(19) United States
(12) Patent Application Publication
(10) Pub. No.: US 2008/0021761 A1
(43) Pub. Date: Jan. 24, 2008

(54) TRANSACTION PROCESSING SYSTEMS AND METHODS

(75) Inventor: Gregory John Rable, Marietta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: FACTORTRUST, INC., Atlanta, GA (US)

(21) Appl. No.: 11/458,887

(22) Filed: Jul. 20, 2006

(51) Int. Cl. G06Q 30/00

(52) U.S. Cl. 705/10; 705/14

(57) ABSTRACT

An exemplary method of providing a transaction confirmation service to a merchant comprises the steps of: (1) receiving an agreement from a merchant to display a transaction confirmation service icon on a web site associated with a merchant and/or to directly market a transaction confirmation service to customers of the merchant; and (2) at least partially in response to receiving the agreement from the merchant, providing at least one transaction confirmation service to the merchant at substantially no charge to the merchant. An exemplary method of providing a transaction confirmation service to a customer includes the steps of: (1) receiving an agreement from the customer to receive at least one particular direct marketing message; and (2) at least partially in response to receiving the agreement from the customer, providing at least one transaction confirmation service to the customer at no charge to the customer.

### BACKGROUND OF THE INVENTION

Monetary transactions, such as on-line purchases of goods or services, often involve a certain level of risk because it is often difficult to determine whether a payment mechanism (such as a payment via a credit card or a transfer of funds from a bank account) has been authorized by the appropriate individual. For example, for on-line purchases made via a credit card, because the merchant is typically not able to see the credit card being used to make the purchase or the individual conducting the transaction, it may be difficult to determine whether the transaction is being made properly by the cardholder, or improperly by another individual who is in possession of the cardholder's account information. Accordingly, there is a need for improved systems and processes for facilitating safe financial transactions (e.g., via the Internet). There is also a need for improved techniques for marketing services related to such systems and processes.

### SUMMARY OF VARIOUS EMBODIMENTS OF THE INVENTION

A method of providing a transaction confirmation service to a merchant according to a particular embodiment of the invention comprises the steps of: (1) receiving a first agreement from the merchant to display a transaction confirmation service icon on a web site associated with the merchant; and (2) at least partially in response to receiving the first agreement from the merchant, providing at least one transaction confirmation service to the merchant at substantially no charge to the merchant. In particular embodiments, the transaction confirmation service includes sending a particular customer of the merchant an SMS message to confirm a particular purchase of goods or services from the merchant by the customer. This is preferably done prior to the particular purchase being charged to the customer.

A method of providing a transaction confirmation service to a merchant according to a further embodiment of the invention comprises the steps of: (1) receiving a first agreement from the merchant to directly market a transaction confirmation service to customers of the merchant; and (2) at least partially in response to receiving the first agreement from the merchant, providing at least one transaction confirmation service to the merchant at substantially no charge to the merchant. In a particular embodiment, under the terms of the first agreement, the merchant agrees to send one or more direct-marketing electronic messages directly to a plurality of the merchant's customers to promote the transaction confirmation service.

A method of providing a transaction confirmation service to a customer according to yet another embodiment of the invention includes the steps of: (1) receiving a first agreement from the customer to receive at least one particular direct marketing message; and (2) at least partially in response to receiving the first agreement from the customer, providing at least one transaction confirmation service to the customer at substantially no charge to the customer. In particular embodiments, this method further includes the step of, after receiving the first agreement from the customer to receive the at least one particular direct marketing message, offering for sale (e.g., auctioning) a right to send the at least one particular direct marketing message to the customer.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a Transaction Processing System according to a particular embodiment of the invention.

FIG. 2 is a diagram of a Transaction Confirmation Server according to one embodiment of the invention.

FIG. 3 is a flowchart of various steps executed within an Account Holder Membership Setup Module according to a particular embodiment of the invention.

FIG. 4 is a flowchart of various steps executed within a Merchant Setup Module according to one embodiment of the invention.

FIGS. 5A and 5B depict a flowchart of various steps executed within a Transaction Confirmation Module according to a particular embodiment of the invention.

FIG. 6 is an exemplary SMS confirmation request message according to a particular embodiment of the invention.

FIG. 7 is an exemplary merchant information screen according to one embodiment of the invention.

FIG. 8 is an exemplary transaction confirmation service enrollment form according to a particular embodiment of the invention.

### DETAILED DESCRIPTION OF VARIOUS EMBODIMENTS OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

### Overview

A transaction processing system according to various embodiments of the invention is adapted to allow an account holder (or other user) to set up a membership with a transaction confirmation service. In doing so, the account holder may provide the system with various information such as information regarding a particular account (e.g., an account number associated with a credit card, debit card, or bank account). The account holder may further provide the system with mobile electronic device contact information (e.g., a cell phone number), that the system may use to automatically confirm certain requested transactions associated with the particular account. In various embodiments, such transactions include, for example, paying for a purchase using funds from a particular account, making a change to the status of the particular account, and transferring funds to or from the particular account.

In addition, the account holder may provide information regarding the circumstances under which transactions made via the specified account should be personally confirmed by the account holder or another designated individual. For example, the account holder may specify that any requested transaction over $100.00 (or any transaction made at a certain type of merchant) involving the account should be personally confirmed by the account holder (or, alternatively, by a designated individual other than the card holder—especially if the card holder is of high school or college age).

Furthermore, when setting up the membership, the account holder may optionally indicate the type of confirmation that should be required to personally confirm each transaction (or transactions satisfying certain specified criteria). For example, in one embodiment, the account holder may specify that they wish to confirm most transactions by simply pressing a certain key (e.g., a “yes” key) on the account holder's cell phone in response to receiving a “request for confirmation” SMS message on the account holder's cell phone. However, the card holder may further specify that they wish to confirm purchase transactions over a certain amount (e.g., over $100) by answering one or more questions regarding: (1) “out of wallet” data associated with the account holder; (2) “in-wallet” data associated with the account holder; and/or (3) any other appropriate data associated with the account holder or the account. This may provide an additional layer of security in confirming these transactions.

In various embodiments, once a membership is set up, if a purchase transaction is paid for using the specified account at a participating merchant (e.g., a retailer participating in the transaction confirmation service), the merchant's computer system sends details of the transaction to a Transaction Confirmation Server associated with the transaction confirmation service. The Transaction Confirmation Server then contacts the account holder in the manner specified by the account holder when the account holder sets up their membership with the transaction confirmation service. For example, the system may transmit a “request confirmation” SMS message to the account holder's cellular phone.

If the Transaction Confirmation Server receives a response from the account holder indicating that the account holder confirms the transaction, the Transaction Confirmation Server sends a message to the merchant's computer system indicating that the user has personally confirmed the transaction. The merchant's computer system then typically approves and processes the transaction.

If the Transaction Confirmation Server does not receive a response from the account holder indicating that the account holder confirms the transaction, the Transaction Confirmation Server sends a message to the merchant's computer system indicating that the account holder has not personally confirmed the transaction. The merchant computer may then, for example, deny the transaction, or attempt to confirm the transaction in another manner (e.g., by having a customer service representative contact the account holder) before determining whether to approve or deny the transaction.

In various embodiments, the system may be adapted to follow a transaction confirmation process similar to the one described above to confirm transactions other than purchase transactions. Such transactions may include, for example, the transfer of money from or to a particular account, or the setup of a new account. The structure and operation of various transaction processing systems and methods are described in greater detail below.

In particular embodiments, the system may be adapted to allow one or more individual merchants (or other entities) to specify the circumstances under which particular transactions with the merchant, or other entity (e.g., transactions involving accounts registered with a particular transaction confirmation service) should be personally confirmed by the account holder or another designated individual. For example, a merchant may specify that any requested purchase transaction with the merchant in an amount over $100.00 involving accounts registered with the transaction confirmation service should be personally confirmed by the account holder (or, alternatively, a designated individual other than the card holder—especially if the card holder is of high school or college age). Furthermore, in various embodiments, the merchant (or other entity) may optionally indicate the type of confirmation that should be required to personally confirm each transaction (or transactions satisfying certain specified criteria). The system may be further configured to automatically facilitate confirmation of transactions according to the particular criteria specified by the merchant (or other entity) as described herein.

### Structure of an Exemplary Transaction Processing System

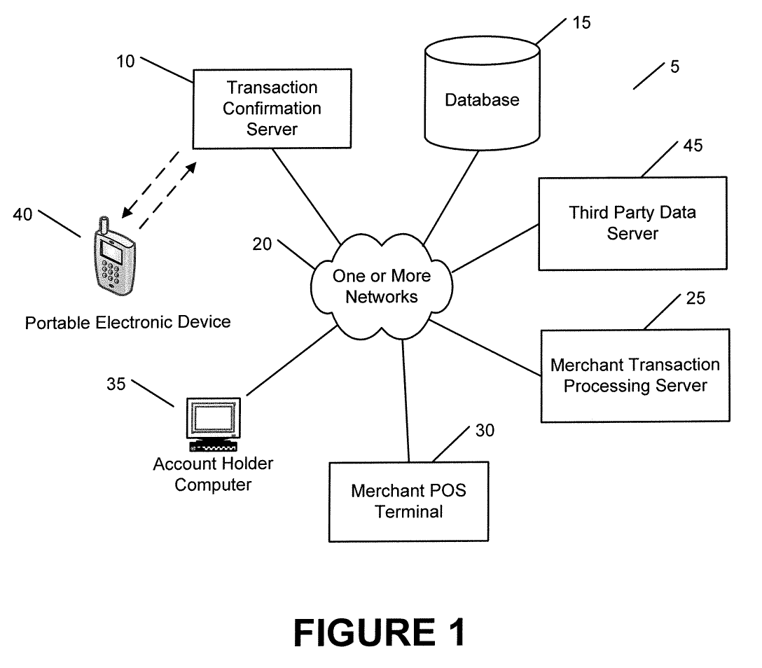

A transaction processing system 5 according to one embodiment of the invention is shown in FIG. 1. As may be understood from this figure, in this embodiment, the system 5 includes at least one: (1) Transaction Confirmation Server 10; (2) Merchant Transaction Processing Server 25; (3) Merchant POS Terminal 30; (4) Account Holder Computer 35; and/or (5) Third Party Data Server 45. As may be understood from FIG. 1, in various embodiments, the system 5 further includes one or more networks 20, such as a LAN or a global communications network (e.g., the Internet) for facilitating communication between one or more of the system's various components. In one embodiment of the invention, the Transaction Confirmation Server 10 is configured for retrieving data from, and for saving data to, a database 15 that may be stored on (or, alternatively, stored remotely from) the Transaction Confirmation Server 10. In the embodiment shown in FIG. 1, the database 15 is maintained on a computer that is remote from the Transaction Confirmation Server 10. In a particular embodiment of the invention, the Transaction Confirmation Server 10 is also configured for communicating (either directly or indirectly) with one or more Portable Electronic Devices 40 (e.g., via an appropriate wireless network).

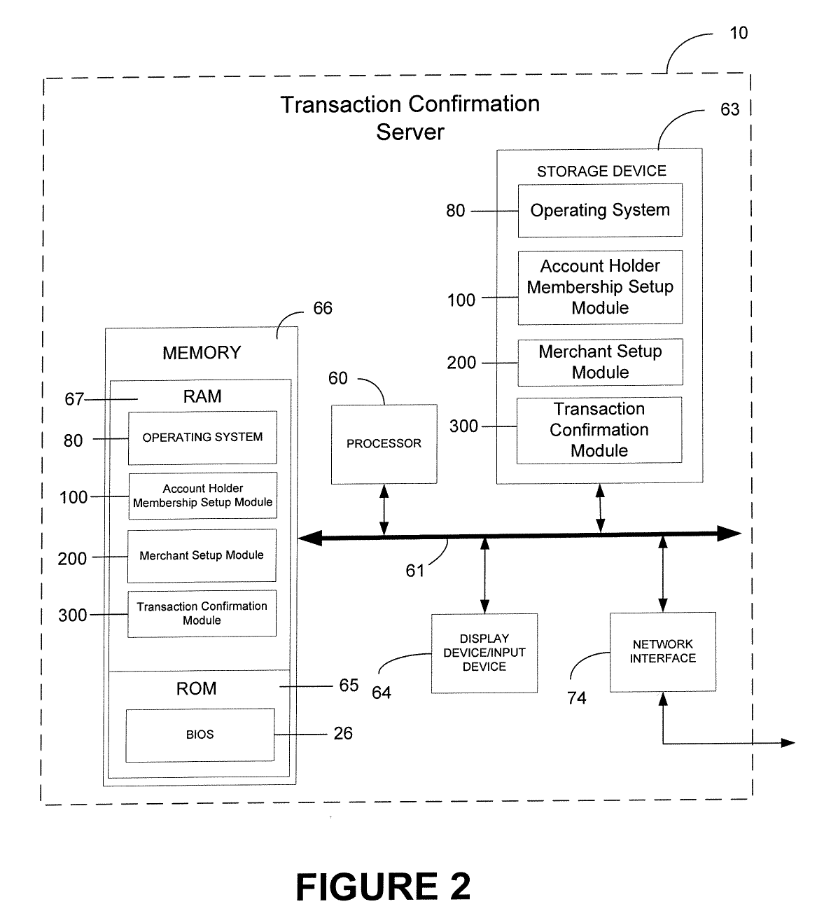

FIG. 2 shows a schematic diagram of a Transaction Confirmation Server 10 according to one embodiment of the invention. As may be understood from this figure, in this embodiment, the Transaction Confirmation Server 10 includes a processor 60 that communicates with other elements within the Transaction Confirmation Server 10 via a system interface or bus 61. Also included in the Transaction Confirmation Server 10 is a display device/input device 64 for receiving and displaying data. This display device/input device 64 may be, for example, a keyboard or pointing device that is used in combination with a monitor. The Transaction Confirmation Server 10 further includes memory 66, which preferably includes both read only memory (ROM) 65 and random access memory (RAM) 67. The server's ROM 65 is used to store a basic input/output system 26 (BIOS), containing the basic routines that help to transfer information between elements within the account administration server 20.

In addition, the Transaction Confirmation Server 10 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 80, an Account Holder Membership Setup Module 100, a Merchant Setup Module 200, and a Transaction Confirmation Module 300. The Account Holder Membership Setup Module 100, Merchant Setup Module 200, and Transaction Confirmation Module 300 control certain aspects of the operation of the Transaction Confirmation Server 10, with the assistance of the processor 60 and an operating system 80.

Also located within the Transaction Confirmation Server 10 is a network interface 74, for interfacing and communicating with other elements of a computer network. It will be appreciated by one of ordinary skill in the art that one or more of the Transaction Confirmation Server 10 components may be located geographically remotely from other Transaction Confirmation Server 10 components. Furthermore, one or more of the components may be combined, and additional components performing functions described herein may be included in the Transaction Confirmation Server 10.

### Operation of Transaction Processing System

The operation of various embodiments of the invention will now be discussed in greater detail. In particular, the Account Holder Membership Setup Module, the Merchant Setup Module, and the Transaction Confirmation Module are described in greater detail below.

### Account Holder Membership Setup Module

In various embodiments of the invention, during the process of completing a transaction with a merchant (e.g., an on-line merchant) that is participating in a transaction confirmation service (e.g., via an appropriate web site), a user is provided the option of signing up for a membership in the service. In a particular embodiment, the user may sign up for this membership by clicking a link on the merchant's web site, which takes the user to a web site associated with the Transaction Confirmation Server 10. In various embodiments of the invention, the Transaction Confirmation Server 10 then runs an Account Holder Membership Setup Module 100. However, in alternative embodiments, the Account Holder Membership Setup Module 100 may be run on one or more other system components.

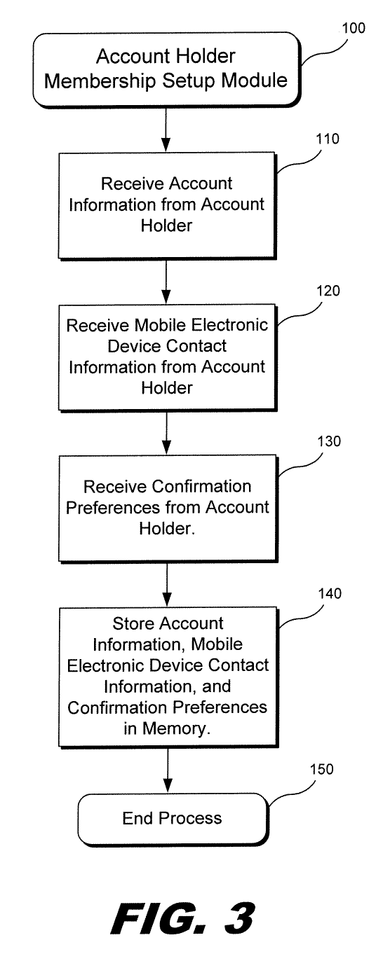

An Account Holder Membership Setup Module 100 according to a particular embodiment of the invention is shown in FIG. 3. As may be understood from this figure, when executing the Account Holder Membership Setup Module 100, the system first advances to Step 110, where it receives account information from the user (e.g., the account holder). In various embodiments of the invention, the system receives this information (and/or one or more other types of information referenced herein) from the account holder as the account holder enters the information into the system via an appropriate web interface. However, this information may be received in any other appropriate manner (e.g., via an automated voice entry system, an automated attendant system, or manual entry by a customer service representative).

The account information received at Step 110 may include, for example, an account identifier (e.g., an account number) associated with an account (e.g., a credit card account, or bank account) that the account holder would like to have covered by the transaction confirmation service. The account information may also include, for example: (1) an account type associated with the account; (2) the account's expiration date; (3) a bank associated with the account; and/or (4) other pertinent account-related information.

Next, the system advances to Step 120, where it receives mobile electronic device contact information from the account holder (e.g., information that may be used to facilitate communication with one or more portable electronic devices). This information may include, for example, a cell phone number (e.g., the account holder's cell phone number), an e-mail address (e.g., the account holder's e-mail address), and/or an electronic device PIN number.

The system then proceeds to Step 130, where it receives confirmation preferences from the account holder. These confirmation preferences may, for example, define the circumstances under which transactions made via the specified account should be personally confirmed by the account holder or other designated individual. For example, the account holder may specify that any requested transaction over $100.00 (or any transaction made at a certain type of merchant) associated with the specified account should be personally confirmed with the account holder (or, alternatively, another designated individual—especially if the card holder is of high school or college age).

Furthermore, the confirmation preference information may optionally indicate the type of confirmation that should be required to personally confirm a transaction (e.g., as determined by the account holder). For example, in one embodiment, the account holder may specify that they wish to confirm a first specified type of transaction (e.g., purchase transactions of less than a specified dollar amount) by simply pressing a certain key (e.g., a “yes” key) on the account holder's cell phone in response to receiving a “request for confirmation” SMS message on the account holder's cell phone. Alternatively, the card holder may specify that they wish to confirm a second specified type of transactions (e.g., purchase transactions over a specified dollar amount) by answering one or more questions regarding “out of wallet” data associated with the account holder. This overall approach may serve to provide an additional layer of security in confirming high-dollar purchase transactions, while providing additional convenience in approving low-dollar purchase transactions. Alternatively, the user may specify that they wish to confirm all transactions using the same method (e.g., by pressing a certain key on their cell phone in response to receiving a “request for confirmation” SMS message.)

Next, after receiving the account information, mobile electronic device contact information, and confirmation preferences from the account holder (or other user), the system advances to Step 140 where it stores this information in the system's memory (e.g., in an appropriate database 15 associated with the Transaction Confirmation Server 10). Finally, the system advances to Step 150 where it ends execution of the Account Holder Membership Setup Module 100.

### Merchant Setup Module

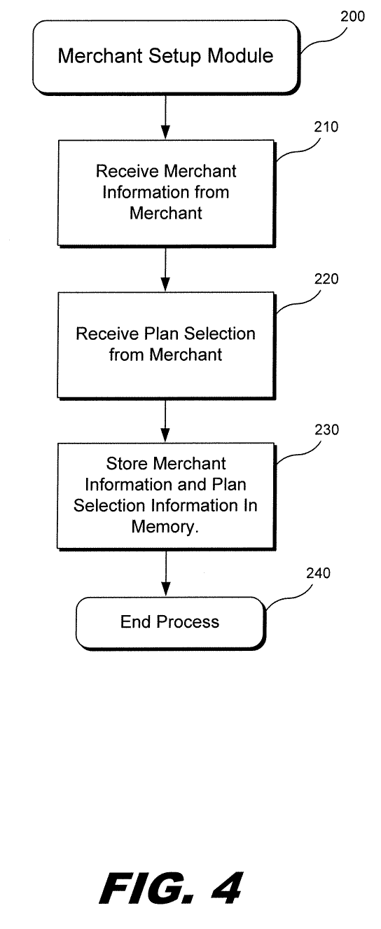

In particular embodiments of the invention, before being able to use a transaction confirmation service associated with the Transaction Confirmation Server 10, individual merchants must sign up for a particular transaction confirmation service. In various embodiments of the invention, this is done via a Merchant Setup Module such as the Merchant Setup Module 200 shown in FIG. 4. In various embodiments of the invention, the Merchant Setup Module 200 is executed by the Transaction Confirmation Server 10. However, in alternative embodiments, the Merchant Setup Module 200 may be executed by one or more of the system's other components.

Turning to FIG. 4, in various embodiments, when executing an exemplary Merchant Setup Module 200, the system first proceeds to Step 210 where it receives merchant information from the merchant who is signing up for the service. This information (and other information described herein) may be received, for example, via: (1) an appropriate web interface; (2) entry by a customer service representative; (3) an automated attendant; or (4) any other suitable method. The merchant information referenced in Step 210 may include, for example, the merchant's name, address, phone number, web site, type of business, and/or any other suitable information related to the merchant.

Next, the system advances to Step 220, where it receives an appropriate plan selection from the merchant. In various embodiments, under particular merchant plans, merchants are charged a predetermined amount for each transaction that is processed (e.g., confirmed or attempted to be confirmed) via the transaction confirmation system. In alternative embodiments, merchants may pay a flat rate for unlimited transaction confirmations.

Next, the system advances to Step 230 where it stores the merchant information and plan selection information received in Steps 210 and 220 in the system's memory (e.g., in a database 15 associated with the Transaction Confirmation Server 10). Finally, the system advances to Step 240 where it ends execution of the Merchant Setup Module 200.

In particular embodiments, the system may be adapted to allow one or more individual merchants (or other entities) to specify the circumstances under which transactions with the merchant, or other entity (e.g., purchase transactions with the merchant involving accounts registered with a particular transaction confirmation service) should be personally confirmed by the account holder or another designated individual. For example, the merchant may specify that any requested transaction with the merchant over $100.00 involving accounts registered with the transaction confirmation service should be personally confirmed by the account holder associated with the account at issue (or, alternatively, a designated individual other than the card holder—especially if the card holder is of high school or college age).

Furthermore, the merchant (or other entity) may optionally indicate the type of confirmation that should be required to personally confirm each transaction (or transactions satisfying certain specified criteria). For example, the merchant (or other entity) may indicate that the account holder should be required to confirm each transaction by answering a question regarding out-of-wallet (or in-wallet) data associated with the account holder or the account at issue. The system may be further configured to automatically facilitate confirmation of transactions according to the criteria specified by the merchant (or other entity) as described herein.

### Transaction Confirmation Module

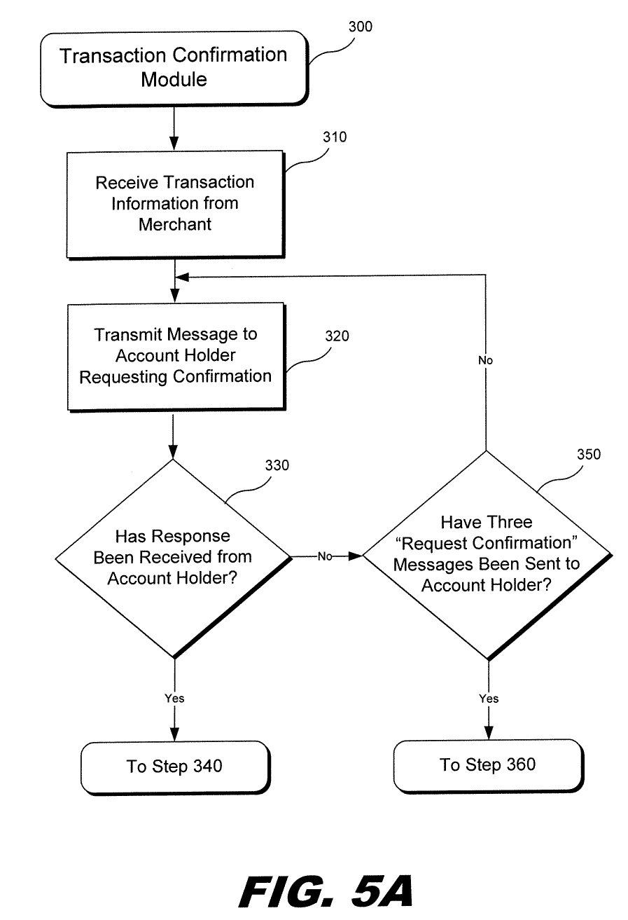

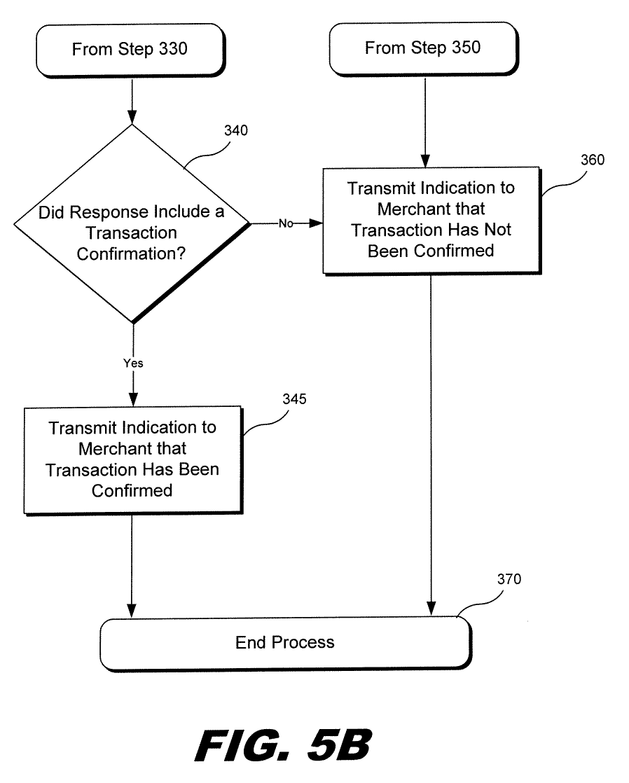

In various embodiments of the invention, once a particular merchant and account holder are set up to participate in the transaction confirmation service, in response to pre-determined criteria regarding a particular transaction being satisfied (e.g., pre-determined criteria specified by the account holder or merchant as described above), the system automatically facilitates confirmation of the transaction. For example, in one embodiment, if a user requests to pay for a particular purchase transaction using a specified account (e.g., the account specified by the account holder at Step 110 above) at a participating merchant (e.g., a retailer that is registered to participate in the transaction confirmation service), the merchant's computer system sends details of the requested transaction to a Transaction Confirmation Server 10 associated with the transaction confirmation service. The Transaction Confirmation Server 10 then executes a Transaction Confirmation Module 300, such as the Transaction Confirmation Module 300 shown in FIGS. 5A and 5B.

As may be understood from these figures, when executing an exemplary Transaction Confirmation Module 300, the system begins at Step 310 where it receives transaction information from a merchant with whom a request has been made to pay for a transaction using a particular account that has been registered with the transaction confirmation service. This transaction information may include, for example, one or more of the following types of information associated with the transaction: (1) an account number associated with the account from which payment has been requested; (2) the requested payment amount; (3) the name of the individual requesting the payment; (4) the merchant category code of the merchant involved in the transaction; (5) the type of goods or services involved in the transaction; and/or (6) any other suitable type of information associated with the transaction.

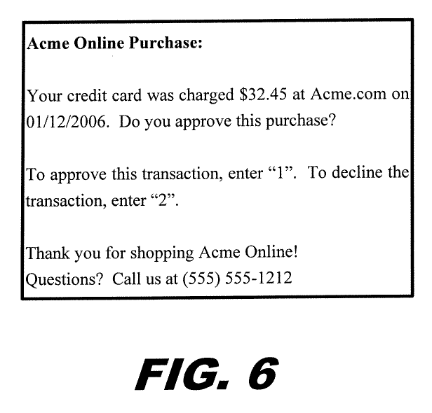

Next, the system advances to Step 320 where it transmits a message to the account holder (or other individual who has been designated to confirm transactions associated with the particular account) requesting confirmation that the account holder or other designated individual approves the requested transaction. In various embodiments of the invention, this message is sent to an electronic device (e.g., a cellular phone) associated with the account holder (or other designated individual) in the form of an SMS message that is generated automatically (or substantially automatically) by the Transaction Confirmation Server 10. The system preferably uses the mobile electronic device contact information that the system received at Step 120 to facilitate transmission of the “confirmation request” message to the appropriate individual. An exemplary SMS “confirmation request” message is shown in FIG. 6.

In alternative embodiments of the invention, the system may transmit the message indicated at Step 320 in a format other than SMS. For example, the system may transmit the message in e-mail format, or in the form of an automated phone call to the account holder or other designated individual.

Next, the system advances to Step 330, where it determines whether the system has received a response to the message transmitted at Step 320 (e.g., from the Account Holder or other designated individual). In various embodiments, this response may be received, for example, via a return SMS message, return e-mail, a phone call, or any other suitable communication vehicle. In particular embodiments, if the system has not received a response after a pre-determined period of time (e.g., 30 seconds), the system proceeds to Step 350, where it determines whether the system has sent a pre-determined number (e.g., 3, 4, or 5) of “Request Confirmation” Messages (e.g., the messages transmitted at Step 320) to the account holder or other designated individual for the current transaction. If not, the system returns to Step 320 where it transmits another message to the account holder requesting confirmation of the requested transaction, and then proceeds as described above.

If, at Step 350, the system determines that it has already sent a pre-determined number (e.g., three) of “request confirmation” messages to the account holder (or other designated individual), the system advances to Step 360, where it transmits an indication to the merchant (e.g., to the merchant's transaction processing computer system) indicating that the transaction has not been confirmed. The system then advances to Step 370, where it ends execution of the Transaction Confirmation Module 300. In response to receiving the message indicating that the transaction has not been confirmed, the merchant (e.g., the merchant's transaction processing server) may, for example: (1) automatically deny the transaction; or (2) attempt to contact the designated individual in another way before determining whether to approve or deny the transaction.

Returning to Step 330 in FIG. 5A, if the system determines that it has received a response from the account holder (or other designated individual), the system advances to Step 340 where it determines whether the response included a confirmation that the account holder (or other designated individual) has confirmed the requested transaction. If so, the system advances to Step 245 where it transmits an indication to the merchant (e.g., the merchant's transaction processing system) that the transaction has been confirmed by the appropriate individual. The system then advances to Step 370, where it ends execution of the Transaction Confirmation Module 300. In response to receiving the message indicating that the transaction has been confirmed, the merchant (e.g., the merchant's transaction processing system) may, for example, automatically approve the transaction.

Returning to Step 340, if the response did not include a transaction confirmation, the system advances to Step 360 where it transmits an indication to the merchant (e.g., to the merchant's transaction processing system) indicating that the transaction has not been confirmed. The system then advances to Step 370, where it ends execution of the Transaction Confirmation Module 300. In response to receiving the message indicating that the transaction has not been confirmed, the merchant (e.g., the merchant's transaction processing system) may, for example: (1) automatically deny the transaction; or (2) attempt to contact the designated individual in another way before determining whether to approve or deny the transaction.

In particular embodiments, if the transaction processing system receives a response from the account holder (or other designated individual) specifically denying the transaction, the transaction processing system may send a message to the merchant (e.g., the merchant's transaction processing system) advising the merchant that the transaction has been denied. In response to receiving this information, the merchant's transaction processing system would then typically automatically deny the transaction.

The techniques described herein may also be used in the context of transactions other than purchases. For example, in various embodiments, the techniques described herein may be used to have the account holder (or other designated individual) confirm other types of transactions such as the opening of a new account (e.g., an on-line Bank account), or the transfer of funds from or to a particular account, such as a bank or credit account.

### Confirmation Techniques Requiring Specific Data from the User

As noted above, in various embodiments of the invention, in order to properly confirm a transaction, the transaction processing system may require the account holder (or other designated individual) to provide data (such as data related to the account holder) as at least part of their response to the “request for confirmation” message transmitted at Step 320. This may serve as a further indicator that the individual providing confirmation of the transaction is the correct individual (and not an unauthorized person who is in possession of the electronic device to which the “request for confirmation” message of Step 320 was transmitted).

In particular embodiments of the invention, before generating and transmitting the “request for confirmation” message at Step 320, the Transaction Confirmation Server 10 may receive “out of wallet” data related to the account holder (or other designated individual), or other suitable data (e.g., “in wallet” data), from an appropriate source (e.g., from a database associated with the Transaction Confirmation Server or from a third party source). An appropriate third-party source may be, for example, a third party data provider such as Choice Point or a credit reporting agency such as Equifax or TransUnion.

In particular embodiments, as part of the “request for confirmation” message transmitted at Step 320, the system requests that the account holder (or other designated individual) answer a question regarding this “out of wallet” data (or, alternatively, “in wallet” data) as part of their response to the “request for confirmation” message. In particular embodiments, when determining, at Step 340, whether the account holder's (or other designated individual's) response includes a transaction confirmation, the system determines whether the response includes a correct answer to a question regarding the “out of wallet” data referenced above. If so, in various embodiments, the system determines that the response did include a transaction confirmation. If not, in particular embodiments, the system determines that the response did not include a transaction confirmation.

In various embodiments, if an account holder (or other designated individual) provides an incorrect answer to a question regarding the “out of wallet” data, or other suitable data, the system may return to Step 320 and transmit a new message to the account holder (or other designated individual) that includes a new question regarding the “out of wallet” data, or other suitable data. This may provide the account holder (or other designated individual) with another chance to confirm the transaction without having to submit a new transaction request. The system may be configured to provide the account holder (or other designated individual) with a pre-determined number of tries to answer these types of questions before sending the merchant an indication that the transaction has not been confirmed.

In other embodiments of the invention, rather than receiving data (e.g., “out of wallet” or “in wallet” data) from a third party and then using this data to confirm a particular transaction, the system may: (1) generate and transmit an appropriate “request for confirmation” message to the account holder (or other designated individual)—for example, via an SMS message; (2) after receiving a response to the “request for confirmation” message, transmitting the response to a third party data provider (e.g., a credit reporting agency), which then determines whether the response to the “request for confirmation” message is correct; and (3) receiving an indication from the third party data provider as to whether the response to the “request for confirmation” message is correct. The system may then use the indication from the third party as described above, or in another appropriate manner, to determine whether the transaction has been properly confirmed.

### Confirmation Based on Multiple Factors

In various embodiments, the system may be configured to approve or deny (or to recommend approving or denying) a particular transaction based on one or more of a variety of different factors. Such factors include, for example, (1) a geographical location associated with a particular electronic device (as determined, for example, using an IP Address associated with the electronic device, or, in the case of GPS-equipped electronic devices, GPS techniques); (2) user responses to questions regarding out-of-wallet data associated with a particular account, account holder, or other individual (which may be obtained, for example, as described above); (3) user responses to questions regarding in-wallet data associated with a particular account, account holder, or other individual (which may be obtained, for example, as described above); (4) information regarding whether a cell phone number associated with an electronic device that is used to approve or deny a particular transaction is actually registered to the customer engaging in the transaction (e.g., as determined by accessing a database of cell phone information); and/or (5) information regarding whether a cell phone number associated with an electronic device that is used to approve or deny a particular transaction is registered in a “Do not call” database, or other such database (the assumption being that fraudsters will not register phone numbers in such databases).

Also, in particular embodiments, the system may be adapted to use these factors (or other suitable factors) to assess the relative risk associated with a particular transaction and, optionally, to associate this assessed relative risk (e.g., low, medium, or high risk) with the particular transaction. For example, the system may be configured to assign a “low risk” transaction rating to transactions in which: (1) the system received a correct response from an account holder to a question regarding “out of wallet” data associated with the account holder; and (2) the IP address associated with a particular computer (e.g., a computer from which the system received the correct response to the question) is associated with a “low risk” geographical location (e.g., a geographical location with a relatively low crime rate). As a further example, the system may be configured to assign a “medium risk” transaction rating to transactions in which: (1) the system received a correct response from an account holder to a question regarding “out of wallet” data associated with the account holder; and (2) the IP address associated with a particular computer (e.g., a computer from which the system received the correct response to the question) is associated with a “high risk” geographical location (e.g., a geographical location with a relatively high crime rate).

In particular embodiments, the system may be configured to transmit the transaction risk rating (determined, for example, as described above) to a payment processing system, which may then use the risk rating to determine how much to charge for processing payment for the particular transaction. For example, the payment processing system may charge a first rate for processing “low risk” transactions, a second (e.g., higher) rate for processing “medium risk” transactions, and a third (e.g., highest) rate for processing “high risk” transactions.

### Confirmation by Specified Third Party

As noted above, in some circumstances, it may be desirable to have an individual other than the account holder determine whether to confirm that a particular requested transaction should be processed. For example, this may be particularly useful if the account at issue is a credit card account that has been cosigned by the parents of the account holder (who may be, for example, a college student). In this case, the transaction confirmation system may be set up to, at Step 320, transmit a message to one of the account holder's parents (e.g., via the parent's cell phone) requesting confirmation of transactions involving the specified account.

In various embodiments, the system may be configured, for example, to request confirmation from an individual other than the account holder: (1) for all requested transactions; (2) for all requested transactions over a pre-determined monetary amount; (3) for all requested transactions with a particular type of merchant (which may be determined, for example, by the merchant's merchant category code); and/or (4) for all purchases of a particular type of item (e.g., clothing or alcohol). In particular embodiments, the system may be configured to, at Step 320, request confirmation: (1) from a first individual (e.g., from the account holder's parent via an electronic device associated with the account holder's parent) if predetermined conditions (such as those specified above) are satisfied; and (2) from a second individual (e.g., from the account holder via an electronic device associated with the account holder) if the predetermined conditions aren't satisfied.

### Channel Authentication

In various embodiments of the invention, the system may use any of the techniques described herein (or similar techniques) to authenticate a particular channel of communication with the account holder or other designated individual (e.g., a cellular phone). For example, the system may be adapted to, in response to an individual (e.g., an account holder) setting up a membership in a particular account confirmation service: (1) automatically transmitting a message to the account holder, via the particular channel of communication (e.g., the account holder's cellular phone), requesting that the account holder confirm that the communication channel is functioning properly by responding to the message (e.g., in a particular manner described within the message); (2) receiving, from the individual, a response to the message; (3) using a response to the message to determine whether to authenticate the particular channel of communication; (4) in response to determining to authenticate the particular channel of communication, authenticating the particular channel of communication; and (5) in response to determining not to authenticate the particular channel of communication, not authenticating the particular channel of communication. In various embodiments of the invention, the message to the individual and/or the individual's response is an SMS message. Also, in particular embodiments, the message to the individual may include a question (e.g., regarding “out of wallet” or “in wallet” data associated with the individual), the individual's response may include a response to this question, and the system may be adapted to determine whether the communication channel has been properly authenticated based, at least in part, to the individual's response to the question.

In alternative embodiments, the system may authenticate a particular channel of communication upon the occurrence of an event other than the setup of a membership in a particular account confirmation service. For example, the system may authenticate a particular channel of communication upon a first transaction made using a particular account after the particular account has been registered in the account confirmation service as part of a setup of a membership in the account confirmation service.

### Account Administration

### Membership Administration

In various embodiments of the invention, the system may be adapted to allow users (e.g., account holders or other designated individuals) to change various aspects of the account holder's membership without (or substantially without) human assistance. For example, the system may allow a user to access the system via a particular web site, and to use this web site to modify information regarding the account holder's membership. For example, in various embodiments, the user may use a Membership Administration web site to: (1) modify the account holder's current account number; (2) modify the mobile electronic device contact information associated with the account holder's account; (3) change the confirmation rules associated with the membership (e.g., the conditions under which the account holder, or other designated individual, will be required to confirm transactions involving the account, and/or the conditions under which an individual other than the account holder will be required to confirm transactions); and/or (4) view pertinent information related to the account holder's membership.

### Merchant Administration

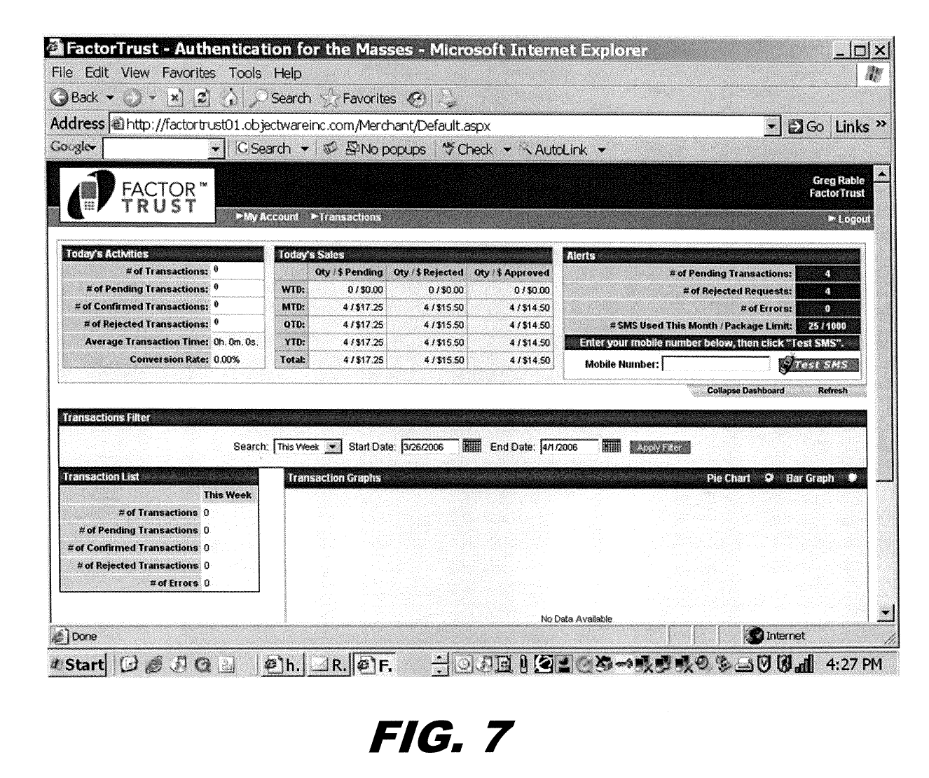

Similarly, in various embodiments of the invention, the system may be adapted to allow merchants to change various aspects of the merchant's account without (or substantially without) human assistance. For example, the system may allow a merchant to access the system via a particular web site, and to use this web site to modify information regarding the merchant's account. For example, in various embodiments, the user may use a Merchant Administration web site to: (1) modify the merchant's current transaction confirmation plan and/or (2) modify the merchant's contact information. The web site may also display, or otherwise provide, information related to the merchant's account. Such information may include, for example: (1) the number of transactions confirmed within a particular period of time; (2) the average amount of time required to confirm the transactions; (3) the merchant's account balance; (4) change the confirmation rules associated with merchant (e.g., the conditions under which registered account holders, or other designated individuals, will be required to confirm transactions involving the merchant) and/or (5) any other pertinent information related to the merchant's account. An exemplary merchant information screen is shown in FIG. 7.

### Marketing Techniques

The transaction confirmation services described herein may be marketed in any of a variety of different ways. For example, the transaction confirmation services may be marketed directly on a transaction confirmation service provider's website or through standard keyword searching advertising services (such as those offered by Google). Other, unique marketing techniques are described below.

### Transaction Confirmation Services in Exchange for Advertising by Merchants

In a particular embodiment of the invention, a provider of transaction confirmation services (e.g., a “transaction confirmation service provider”) may market their services by offering to provide one or more transaction confirmation services to a particular merchant in exchange for: (1) the particular merchant agreeing to display an icon associated with the transaction confirmation service (e.g., a “transaction confirmation service icon”) on the merchant's web page; and/or (2) the merchant agreeing to directly market the transaction confirmation service to one or more of the transaction confirmation service's customers.

In one embodiment of the invention, the transaction confirmation service provider may agree to provide confirmation services for all (or substantially all) transactions (e.g., purchase transactions) conducted on one or more web sites associated with the particular merchant at least partially in exchange for the particular merchant agreeing to display an icon associated with the transaction confirmation service on the merchant's web page for a pre-determined period of time. For example, the transaction confirmation service provider may agree to provide transaction confirmation services for all (or substantially all) transactions conducted on the particular merchant's web site at no cost (or at substantially no cost) to the merchant as long as the particular merchant displays an icon associated with the transaction confirmation service on the merchant's web site. In a particular embodiment of such an arrangement, the transaction confirmation service provider would stop providing free confirmation services to the merchant in response to the merchant removing the transaction confirmation service icon from the merchant's web page.

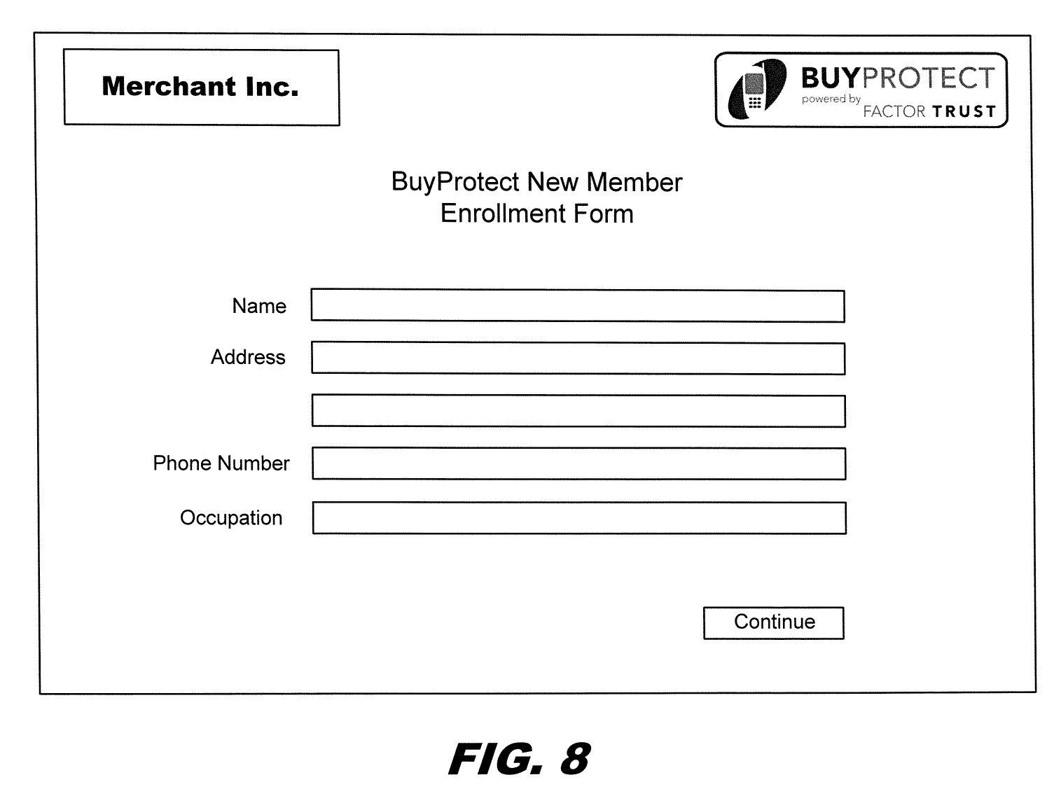

In various embodiments of the invention described above, the transaction confirmation service icon provides a link to a web site that is adapted to facilitate enrolling new users in the transaction confirmation service. For example, this web site may include: (1) information regarding the transaction confirmation service; and/or (2) a new user application form that a new user may complete to enroll in the transaction confirmation service (e.g., via the Internet). In various embodiments, the web site may be co-branded by the transaction confirmation service and a particular merchant as shown in the exemplary transaction confirmation service enrollment form of FIG. 8.

As noted above, in various embodiments, the transaction confirmation service provider may agree to provide one or more transaction confirmation services to a particular merchant at no charge (or at substantially no charge) to the particular merchant at least partially in response to the particular merchant agreeing to directly market the transaction confirmation service to one or more of the particular merchant's customers. In particular embodiments, the merchant may satisfy this direct marketing requirement by, for example, sending, to one or more of the merchant's existing customers, at least one electronic message (e.g., an e-mail or SMS message) advertising the transaction confirmation service. In particular embodiments, the e-mail includes a link to a web site (such as the type of web site discussed above) that is adapted to facilitate enrolling new users in the transaction confirmation service.

In various embodiments of the invention, the transaction confirmation service provider may agree to provide one or more transaction confirmation services to a particular merchant at least partially in response to the particular merchant agreeing to directly market the transaction confirmation service to one or more of the particular merchant's customers according to a pre-determined schedule. In particular embodiments, the merchant may satisfy this direct marketing requirement by, for example, sending at least one electronic message (e.g., an e-mail or SMS message) to one or more of the merchant's existing customers according a pre-determined schedule agreed upon by the transaction confirmation service provider and the merchant. Such a schedule may provide, for example, that the merchant will directly market the transaction confirmation service to each of the merchant's customers via an appropriate electronic message at least once (or any other appropriate number of times) within a particular time period (e.g., per month or year).

### Monetary Compensation in Exchange for Facilitating New Enrollments

As a further incentive for promoting the transaction confirmation service, the transaction confirmation service provider may agree to pay the particular merchant a pre-determined amount that is based at least in part on the number of new customers that enroll in the transaction confirmation service via a link provided: (1) on the merchant's web site; and/or (2) within a direct marketing e-mail sent by the merchant to individuals who enrolled as new customers. For example, the transaction confirmation service provider may agree to pay the merchant $1.00 (or other pre-determined amount) for each new customer that enrolls in the transaction confirmation service via a link provided: (1) on the merchant's web site; and/or (2) within a direct marketing e-mail sent to the new customer by the merchant. It should be understood in light of the discussion above that other payment schedules may be used. For example, the transaction confirmation service provider may agree to pay the merchant a predetermined amount (e.g., $110) for each pre-determined number (e.g., each 100) of new customers that the merchant facilitates enrolling in the transaction confirmation service.

### Transaction Confirmation Services in Exchange for Agreement by Individuals to Receive Direct Marketing Messages

In a further embodiment of the invention, a transaction confirmation service provider may agree to provide at least one of the transaction confirmation services described herein to an individual at no cost (or at substantially no cost) to the individual in exchange for the individual agreeing to receive one or more direct marketing messages. These direct marketing messages may, for example, be sent to the individual via the same line of communication through which transaction confirmation messages are sent to the individual. Such lines of communication include, for example, SMS messages sent to a portable electronic device (e.g., a cell phone or personal digital assistant) to which the individual has requested that the transaction confirmation service send the individual's transaction confirmation messages.

In particular embodiments, the transaction confirmation service provider may agree to provide unlimited, free (or substantially free) transaction confirmation services for all purchases made by a particular individual during a particular discrete period of time in exchange for the individual agreeing to receive a pre-determined number of direct marketing messages (e.g., one, two or three direct marketing messages) during that discrete period of time. In a preferred embodiment of the invention, these direct marketing messages include electronic messages delivered to a portable electronic device (e.g., a cell phone or personal digital assistant) to which the individual has requested that the transaction confirmation service send the individual's transaction confirmation messages.

### Sale of Rights to Directly Market to Individuals

Once a particular individual agrees to receive at least one direct marketing message in exchange for receiving free (or substantially free) transaction confirmation services, the transaction confirmation service provider (or other appropriate entity) may offer for sale the right to send the at least one direct marketing message to the individual. These rights to send direct marketing messages to the individual may be sold individually, or as part of a larger bundle of marketing rights.

For example, the transaction confirmation service provider may offer to sell a bundle of marketing rights that include: (1) the right to send direct marketing messages to a particular individual; and (2) the right to send direct marketing messages to other individuals who have characteristics that are similar to those of the particular individual. For example, the transaction confirmation service provider may offer, as part of a single transaction, to sell the right to send direct marketing messages to 10,000 individuals who have purchased a television in the last 30 days. As another example, the transaction confirmation service provider may offer, as part of a single transaction, to sell the right to send direct marketing messages to 5,000 individuals who: (1) are male; (2) are over 35 years old; (3) have an annual household income of over $75,000; and (4) have an interest in sailing.

The various characteristics referenced above (as well as other characteristics of individuals) may, for example, be acquired by the transaction processing system: (1) from information received by the transaction processing system when each individual enrolls in the transaction confirmation service; and (2) from information that the transaction processing system acquires over time during the course of confirming various transactions for the individual. Exemplary processes for acquiring this information are described below.

In a particular embodiment of the invention, each individual will be required to provide at least the following information for the individual when enrolling in the transaction confirmation service: (1) name; (2) address; (3) phone number; (4) occupation; (5) annual household income; and (6) contact information for use in sending SMS messages to the individual (e.g., the individual's cell phone number). In addition, each individual will be asked to optionally provide additional information regarding the individual's interests, hobbies, organizational involvement, and/or other such information. As noted above, this information may be used later to determine characteristics for an individual, which may in turn be used to classify the individual for marketing purposes.

As noted above, the transaction processing system may be configured for identifying characteristics of individuals over time during the course of confirming various transactions for the individuals. For example, the transaction processing system may be configured to store information regarding each transaction that the system processes in a central database. This information may then be used (e.g., as part of a daily or weekly processing job) to identify various characteristics of each individual for which information is stored within the system. For example, the system may use this information to identify individuals who: (1) have purchased a vehicle (or another particular type of item or service) within the last 30 days; or (2) purchase music (or other type of item or service) on-line an average of three or more times every month. These characteristics may then be used, along with the characteristics provided directly by the individual upon enrolling with the transaction service, to classify the individual for marketing purposes.

In various embodiments of the invention, one or more of the following data elements for each particular individual may be used to classify the individual for marketing purposes: (1) real-time, physical location of customer's mobile phone; (2) the type (make and model) of the customer's mobile phone; (3) customer provided demographic info (e.g., home address, age, income level, purchase preferences, and/or interests); (4) data received from a third party data provider, such as a credit reporting agency, based on known data regarding the individual; and (5) information regarding the individual's past purchase transactions (which, as noted above, may be obtained from a database associated with the transaction processing system that is adapted to store information regarding one or more individuals' past purchase transactions in memory).

Techniques for Selling Rights to Directly Market to Individuals

As noted above, once a particular individual agrees to receive one or more direct marketing messages, the transaction confirmation service provider may sell the right to send direct marketing messages to the individual to another entity, such as a particular merchant. In one embodiment of the invention, the transaction confirmation service provider may do this by first grouping the rights to send direct marketing messages to a group of individuals into a bundle of rights, and then offering the resulting bundle of rights for sale to a suitable group of entities (such as merchants).

In various embodiments, the group of individuals are selected so that they have one or more similar data attributes. For example, the transaction confirmation service provider may identify 1000 individuals who: (1) have enrolled in the transaction confirmation service; (2) have agreed to receive, each month, at least one direct marketing message (e.g., an electronic message, such as an SMS message, that is delivered via the same channel of communication as the transaction confirmation messages provided to the individual by the transaction confirmation service); and (3) have purchased a new car within the last 30 days. The transaction confirmation service provider may then offer for sale the right to send one or more direct marketing messages to each of these 1000 individuals. This right may be of particular interest to merchants who sell products that are commonly purchased by people who have recently bought new cars (e.g., products such as car accessories or extended warranties).

In various embodiments of the invention, the transaction processing system is adapted to create bundles of direct marketing rights, such as those discussed above, based on criteria established by appropriate representatives of the transaction confirmation service provider. However, in other embodiments, the transaction processing system may be adapted to automatically establish appropriate criteria and to create bundles of direct marketing rights based on this automatically generated criteria.

In particular embodiments of the invention, once suitable bundles of direct marketing rights are created, the transaction processing system is adapted to offer these bundles of rights for sale to a plurality of potential buyers (e.g., merchants). In one embodiment, once a particular suitable bundle of direct marketing rights is created, the system is adapted to offer the particular bundle of rights to a first group of potential buyers that includes substantially only companies (e.g., only companies) that are enrolled in the transaction confirmation service.

In one embodiment, the system is adapted to auction the particular bundle of rights to the first group of potential buyers, and to end the auction at a pre-determined auction deadline. In a particular embodiment, the entity having placed the highest bid by the auction deadline (and which has satisfied any minimum bid requirements) will win the auction.

In one embodiment, if an appropriate winning bid is not placed by the pre-determined auction deadline, the particular bundle of rights may be offered for sale (e.g., for auction) to a second group of potential buyers. This second group of potential buyers may include, for example, entities that are not enrolled in the transaction confirmation service.

It should be understood that the system may use any appropriate sale or auctioning technique to sell (e.g., auction) the various bundles of rights. Such techniques include those currently used by eBay and Amazon.com, but could include other suitable techniques. In various embodiments, the sale and/or auction of various bundles of rights may be conducted, at least in part, via the transaction processing system's dashboard.

### Content of Direct Marketing Messages

Any suitable content may be included in the direct marketing messages referenced above. In various embodiments, the content of a direct marketing message sent to a particular individual may be based, at least in part, on one or more of such factors as: (1) the real-time, physical location of the individual's mobile phone; (2) the type (e.g., make and/or model) of the individual's mobile phone; (3) demographic information provided by the individual upon enrollment in the transaction confirmation service (e.g., the individual's home address, age, or income level); (4) data received from a third party (e.g., a credit reporting agency) regarding the individual; (5) one or more of the individual's interests and/or purchase preferences (e.g., as provided by the individual upon enrollment in the transaction confirmation service); and (6) information regarding the individual's purchase transaction history (which, as noted above, may be stored in memory by the transaction processing system).

### CONCLUSION

Many modifications and other embodiments of the invention will come to mind to one skilled in the art to which this invention pertains having the benefit of the teachings presented in the foregoing descriptions and the associated drawings. Accordingly, it should be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

1. A method of providing a transaction confirmation service to a merchant, said method comprising the steps of:
receiving a first agreement from said merchant to display a transaction confirmation service icon on a web site associated with said merchant; and
at least partially in response to receiving said first agreement from said merchant, providing at least one transaction confirmation service to said merchant at substantially no charge to said merchant.

2. The method of claim 1, wherein said transaction confirmation service includes:
sending a particular customer an SMS message to confirm a particular purchase by said customer from said merchant prior to said particular purchase being charged to said customer.

3. The method of claim 2, wherein said transaction confirmation service includes:
in response to receiving a pre-determined response to said SMS message, charging said particular purchase to said customer.

4. The method of claim 2, wherein said transaction confirmation service includes receiving an SMS message from said customer to confirm said particular transaction.

5. The method of claim 1, wherein said transaction confirmation service icon provides a link to a transaction confirmation service enrollment web page that is configured for facilitating enrolling customers in said transaction confirmation service.

6. The method of claim 5, wherein said method further comprises the step of making a payment to said merchant, said payment being at least partially based on a number of customers who use said transaction confirmation service icon on said merchant's web site to facilitate enrolling in said transaction confirmation service within a pre-determined period of time.

7. The method of claim 1, said method further comprising the step of:
receiving a second agreement from said merchant to directly market said transaction confirmation service to customers of said merchant.

8. The method of claim 7, wherein, under the terms of said second agreement, said merchant agrees to send correspondence directly to a plurality of said merchant's customers promoting said transaction confirmation service.

9. The method of claim 7, wherein, under the terms of said second agreement, said merchant agrees to send one or more direct marketing electronic messages directly to a plurality of said merchant's customers promoting said transaction confirmation service.

10. The method of claim 9, wherein said first and second agreements are memorialized in a single contract.

11. A method of providing a transaction confirmation service to a merchant, said method comprising the steps of:
receiving a first agreement from said merchant to directly market said transaction confirmation service to customers of said merchant; and
at least partially in response to receiving said first agreement from said merchant, providing at least one transaction confirmation service to said merchant at substantially no charge to said merchant.

12. The method of claim 11, wherein, under the terms of said first agreement, said merchant agrees to send correspondence directly to a plurality of said merchant's customers promoting said transaction confirmation service.

13. The method of claim 11, wherein, under the terms of said first agreement, said merchant agrees to send one or more direct-marketing electronic messages directly to a plurality of said merchant's customers promoting said transaction confirmation service.

14. A method of providing a transaction confirmation service to a customer, said method comprising the steps of:
receiving a first agreement from said customer to receive at least one particular direct marketing message; and
at least partially in response to receiving said first agreement from said customer, providing at least one transaction confirmation service to said customer at no charge to said customer.

15. The method of claim 14, wherein said method further includes the step of:
after receiving said first agreement from said customer to receive said at least one particular direct marketing message, offering for sale a right to send said at least one particular direct marketing message to said customer.

16. The method of claim 14, wherein said method further includes the step of:
after receiving said first agreement from said customer to receive said at least one particular direct marketing message, auctioning a right to send said at least one particular direct marketing message to said customer.

17. The method of claim 14, wherein:
said method further includes the step of, after receiving said first agreement from said customer to receive said at least one particular direct marketing message, auctioning a right to send said at least one particular direct marketing message to said customer; and
said step of auctioning said right to send said at least one particular direct marketing message to said user comprises auctioning said right to a closed group of merchants, each of said merchants within said closed group of merchants being enrolled in said transaction confirmation service.

18. The method of claim 14, wherein:
said method further includes the step of, after receiving said first agreement from said customer to receive said at least one particular direct marketing message, offering for sale a right to send said at least one particular direct marketing message to said user; and
said step of offering said right for sale comprises offering said right for sale to a first group of merchants.

19. The method of claim 18, wherein said step of offering said right for sale comprises:
offering said right for sale to said first group of merchants for a predetermined period of time, and
in response to said right not being sold within said predetermined period of time to said first group of merchants, offering said right for sale to a second group of merchants.

20. The method of claim 19, wherein:
said first group of merchants is a closed group of merchants, each of said merchants within said closed group of merchants being enrolled in said transaction confirmation service; and
said second group of merchants comprises at least one merchant that is not enrolled in said transaction confirmation service.
